(19) United States
(12) Patent Application Publication
(10) Pub. No.: US 2025/0361631 A1
(43) Pub. Date: Nov. 27, 2025

(54) TRANSITION METAL-DOPED OXIDE NANOPARTICLES GROWN ON NICKEL FOAM FOR ELECTROCHEMICAL GENERATION OF HYDROGEN

(71) Applicant: KING FAHD UNIVERSITY OF PETROLEUM AND MINERALS, Dhahran (SA)

(72) Inventors: Mohamed Jaffer Sadiq MOHAMED, Dhahran (SA); Muhammad Ashraf GONDAL, Dhahran (SA)

(73) Assignee: KING FAHD UNIVERSITY OF PETROLEUM AND MINERALS, Dhahran (SA)

(21) Appl. No.: 18/673,778

(22) Filed: May 24, 2024

(51) Int. Cl. C25B 11/077; C25B 1/04; C25B 11/031; C25B 11/052; C25B 11/061

(52) U.S. Cl. CPC C25B 11/0771; C25B 1/04; C25B 11/031; C25B 11/052; C25B 11/061

(57) ABSTRACT

A method of generating hydrogen using an electrocatalyst including NiMoₓCo₂₋ₓO₄ nanoparticles deposited on a nickel foam substrate, where x>0 and x≤0.06. A first portion of the NiMoₓCo₂₋ₓO₄ nanoparticles have a nano-needle morphology, where the nano-needles assemble to form a sphere in which the nano-needles project horizontally from the sphere, and the sphere has an average diameter of 1-5 micrometers (μm).

### STATEMENT OF PRIOR DISCLOSURE BY INVENTOR

Aspects of the present disclosure are described in R. S. Alkhaldi, M. A. Gondal, M. J. S. Mohamed, M. A. Almessiere, A. Baykal, S. Caliskan, and Y. Slimani “Chestnut-like Molybdenum-Doped Nickel Cobaltite Spinel Oxide Nanoparticles Grown on Ni Foam as the Electrocatalyst for the Hydrogen Evolution Reaction”; ACS Appl. Nano Mater. 2024, 7, 3, 2867-2878, incorporated herein by reference in its entirety.

### STATEMENT OF ACKNOWLEDGEMENT

Support provided by the King Fahd University of Petroleum and Minerals (KFUPM) is gratefully acknowledged.

### BACKGROUND

### Technical Field

The present disclosure is directed towards hydrogen generation, more particularly directed towards a method of generating hydrogen using transition metal doped oxide nanoparticles grown on nickel foam.

### Description of Related Art

The “background” description provided herein is to present the context of the disclosure generally. Work of the presently named inventors, to the extent it is described in this background section, as well as aspects of the description that may not otherwise qualify as prior art at the time of filing, are neither expressly nor impliedly admitted as prior art against the present invention.

Developing renewable energy technology that can protect the environment and balance energy supply and demand is necessary to ensure socio-economic development. Oxygen (O₂) gas is considered the precursor to clean combustion and is used in a plurality of industrial processes such as, but not limited to, combustion, oxidation, flame hardening, and flame cleaning. Subsequently, hydrogen (H₂) has been viewed as a clean and high-density energy carrier for mitigating increasing environmental issues and global warming caused by the combustion of fossil fuels. Hydrogen is environmentally friendly, easy to convert into electricity or other forms of fuel with relatively high efficiencies and has convenient ways of storage. Currently, H₂ can be generated from partial oxidation, gasification, and steam reforming of hydrocarbons. However, the main drawbacks to these methods of processing are high operational costs and high temperatures and pressures, in addition to the large consumption of fossil fuels such as natural gas, which results in CO₂ emissions.

Thus, substantial efforts have been made to explore cleaner, more sustainable, and energy-efficient routes of hydrogen production. In such context, hydrogen may be obtained by the electrolysis of H₂O in an electrolytic cell. In the electrolytic cell, hydrogen evolution reaction (HER) occurs at a cathode, and oxygen evolution reaction (OER) occurs at an anode. For both HER and OER, a suitable catalyst is vital for electrochemical water splitting. The catalyst must possess favorable qualities such as, but not limited to, low-cost, ease of preparation, high electrochemical activity, natural abundance, and long-term stability.

Presently, platinum (Pt), ruthenium (Ru), and iridium (Ir) based materials are extensively used for HER and OER, despite having high cost, low abundance, and poor stability under harsh conditions. Therefore, a need arises for designing a high-performance and low-cost electrocatalyst for HER and OER.

Spinel metal oxide (MO) nanostructures have been explored as potential catalysts due to their large surface area. Further, including additional metals to produce mixed transition MOs can alter HER electrode catalytic performance. Spinel oxides have a formula of AB₂O₄ (A=Mn, Cu, Co, Zn, Fe, Ni; B═Cr, Ni, Mn, Mo, Co) and can have normal, inverse, or complex structures determined by cation occupation of octahedral (Oh) or tetrahedral (Td) sites. Spinel-type oxides can improve catalytic performance, due to the structure, morphology, controllable composition, and valence of the spinel oxides.

Although several materials as OER/HER electrocatalysts have been developed in the past, there still exists a need to develop a method for water splitting that may circumvent the drawbacks of the prior art. It is one object of the present to make an efficient electrocatalyst for generating hydrogen in an environmentally friendly manner.

### SUMMARY

In an exemplary embodiment, a method of generating hydrogen is described. The method includes applying a potential of 0.1 to 2 V to an electrochemical cell. The electrochemical cell is at least partially submerged in an aqueous solution; on applying the potential, the aqueous solution is reduced, forming the hydrogen. The electrochemical cell includes a counter electrode and an electrocatalyst. The electrocatalyst includes a nickel foam substrate and NiMoₓCo₂₋ₓO₄ nanoparticles as such, x>0 and x≤0.06. The NiMoₓCo₂₋ₓO₄ nanoparticles are distributed on the surface of the nickel foam substrate. A first portion of the NiMoₓCo₂₋ₓO₄ nanoparticles have a nano-needle morphology, where the nano-needles assemble to form a sphere in which the nano-needles project horizontally from the sphere, and the sphere has an average diameter of 1-5 micrometers (μm).

In some embodiments, the NiMoₓCo₂₋ₓO₄ nanoparticles have a cubic spinel oxide crystal structure.

In some embodiments, the NiMoₓCo₂₋ₓO₄ nanoparticles have a crystallite size of 12-18 nanometers (nm).

In some embodiments, Mo is only present at octahedral sites in the NiMoₓCo₂₋ₓO₄ nanoparticles.

In some embodiments, the nano-needles are uniformly spaced to form the sphere, and the spacing between the nano-needles forms a porous structure.

In some embodiments, the nano-needles have an average width of 10-30 nm.

In some embodiments, a second portion of the NiMoₓCo₂₋ₓO₄ nanoparticles have a morphology of spheres with an average diameter of 0.1-3 μm.

In some embodiments, the NiMoₓCo₂₋ₓO₄ nanoparticles include 1-20% of the first portion and 80-99% of the second portion, based on a total amount of the NiMoₓCo₂₋ₓO₄ nanoparticles.

In some embodiments, the NiMoₓCo₂₋ₓO₄ nanoparticles include Ni(II), Ni(III), Co(II), and Co(III).

In some embodiments, the NiMoₓCo₂₋ₓO₄ nanoparticles are hydrothermally grown on the nickel foam substrate.

In some embodiments, the NiMoₓCo₂₋ₓO₄ nanoparticles form a continuous layer on the nickel foam substrate.

In some embodiments, the counter electrode includes at least one of graphite and platinum.

In some embodiments, the aqueous solution includes water and a base.

In some embodiments, the electrocatalyst has a Tafel slope of 60-115 millivolts/decade (mVdec⁻¹).

In some embodiments, x=0.04, and the electrocatalyst has a Tafel slope of 60-65 mVdec⁻¹.

In some embodiments, the electrocatalyst has an overpotential of 200-300 mV at 10 milliampere per square centimeters (mA/cm²).

In some embodiments, x=0.04, and the electrocatalyst has an overpotential of 220-230 millivolts (mV) at 10 mA/cm².

In some embodiments, the electrocatalyst has an electrochemically active surface area of 12-22 centimeters squared (cm²).

The foregoing general description of the illustrative present disclosure and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is a schematic illustration of the synthesis of three-dimensional (3D) NiMoₓCo₂₋ₓO₄ (x≤0.06) chestnut-like spinel oxide nanoparticles (CNSPs) grown on nickel foam (NF), according to certain embodiments.

FIG. 2 are X-ray diffraction (XRD) powder patterns of NiMoₓCo₂₋ₓO₄ (x≤0.06) CNSPs grown on NF and bare NF, according to certain embodiments.

FIG. 3A are field emission scanning electron microscopy (FESEM) images of NiMoₓCo₂₋ₓO₄ CNSPs grown on NF at different magnifications, according to certain embodiments.

FIG. 3B is a scanning electron microscope (SEM) image of NiMoₓCo₂₋ₓO₄ (x=0.00) CNSPs grown on NF, according to certain embodiments.

FIG. 3C is a SEM image of NiMoₓCo₂₋ₓO₄ (x=0.02) CNSPs grown on NF, according to certain embodiments.

FIG. 3D is a SEM image of NiMoₓCo₂₋ₓO₄ (x=0.04) CNSPs grown on NF, according to certain embodiments.

FIG. 3E is a SEM image of NiMoₓCo₂₋ₓO₄ (x=0.06) CNSPs grown on NF, according to certain embodiments.

FIG. 3F is a SEM image of NiMoₓCo₂₋ₓO₄ (x=0.00) CNSPs, according to certain embodiments.

FIG. 3G is a SEM image of NiMoₓCo₂₋ₓO₄ (x=0.02) CNSPs, according to certain embodiments.

FIG. 3H is a SEM image of NiMoₓCo₂₋ₓO₄ (x=0.04) CNSPs, according to certain embodiments.

FIG. 3I is a SEM image of NiMoₓCo₂₋ₓO₄ (x=0.06) CNSPs, according to certain embodiments.

FIG. 4A is a transmission electron microscopy (TEM) image of NiMoₓCo₂₋ₓO₄ (x=0.04) CNSPs grown on NF, at 200 nanometers (nm) magnification, according to certain embodiments.

FIG. 4B is a TEM image of NiMoₓCo₂₋ₓO₄ (x=0.04) CNSPs grown on NF at 20 nm magnification, according to certain embodiments.

FIG. 4C is a high-resolution-TEM (HRTEM) image of NiMoₓCo₂₋ₓO₄ (x=0.04) CNSPs grown on NF at 10 nm magnification, according to certain embodiments.

FIG. 5A shows an X-ray photoelectron spectroscopy (XPS) survey spectrum of NiMoₓCo₂₋ₓO₄ (x=0.04) CNSPs, according to certain embodiments.

FIG. 5B shows XPS analysis of NiMoₓCo₂₋ₓO₄ (x=0.04) CNSPs with spectrum of Co 2p, according to certain embodiments.

FIG. 5C shows XPS analysis of NiMoₓCo₂₋ₓO₄ (x=0.04) CNSPs with spectrum of Ni 2p, according to certain embodiments.

FIG. 5D shows XPS analysis of NiMoₓCo₂₋ₓO₄ (x=0.04) CNSPs with spectrum of 0 Is, according to certain embodiments.

FIG. 5E shows XPS analysis of NiMoₓCo₂₋ₓO₄ (x=0.04) CNSPs with spectrum of Mo 3d, according to certain embodiments.

FIG. 6A shows linear sweep voltammetry (LSV) polarization curves of NiMoₓCo₂₋ₓO₄ (x≤0.06) CNSPs electrocatalysts using NF as a substrate, according to certain embodiments.

FIG. 6B shows an overpotential histogram of NiMoₓCo₂₋ₓO₄ (x≤0.06) CNSPs electrocatalysts on a NF substrate, according to certain embodiments.

FIG. 6C shows Tafel plots of NiMoₓCo₂₋ₓO₄ (x≤0.06) CNSPs electrocatalysts, according to certain embodiments.

FIG. 6D shows cyclic voltammetry (CV) curves of NiMoₓCo₂₋ₓO₄ (x=0.04) CNSPs electrocatalyst, according to certain embodiments.

FIG. 6E shows double layer capacitance (C_{dl}) graph of NiMoₓCo₂₋ₓO₄ (x≤0.06) CNSPs electrocatalysts in 1M KOH solution, according to certain embodiments.

FIG. 6F shows an electrochemical surface area (ECSA) histogram of NiMoₓCo₂₋ₓO₄ (x≤0.06) CNSPs electrocatalysts in 1M KOH solution, according to certain embodiments.

FIG. 7A shows roughness factors (RF) of NiMoₓCo₂₋ₓO₄ (x≤0.06) CNSPs electrocatalysts, according to certain embodiments.

FIG. 7B shows active sites of NiMoₓCo₂₋ₓO₄ (x≤0.06) CNSPs electrocatalysts, according to certain embodiments.

FIG. 7C shows specific current activity in mA/cm² of NiMoₓCo₂₋ₓO₄ (x≤0.06) CNSPs electrocatalysts, according to certain embodiments.

FIG. 7D shows electrochemical impedance spectroscopy (EIS) spectra of NiMoₓCo₂₋ₓO₄ (x≤0.06) CNSPs electrocatalysts, according to certain embodiments.

FIG. 7E shows a chronopotentiometry curve of NiMoₓCo₂₋ₓO₄ (x=0.4) CNSPs electrocatalyst, according to certain embodiments.

FIG. 7F is a schematic illustration of a proposed hydrogen evolution reaction (HER) mechanism in 1M KOH solution, according to certain embodiments.

FIG. 8 is a schematic illustration of unit cells for adsorption of hydrogen on molybdenum doped CNSP (M_{II}CNSP—H) and adsorption of water on molybdenum doped CNSP (M_{I}CNSP—W), according to certain embodiments.

### DETAILED DESCRIPTION

When describing the present disclosure, the terms used are to be construed in accordance with the following definitions, unless a context dictates otherwise.

Embodiments of the present invention will now be described more fully hereinafter with reference to the accompanying drawings wherever applicable, in that some, but not all embodiments of the disclosure are shown.

Where a numerical limit or range is stated herein, the endpoints are included. Also, all values and subranges within a numerical limit or range are specifically included as if explicitly written out.

In the drawings, like reference numerals designate identical or corresponding parts throughout the several views. Further, as used herein, the words “a”, “an” and the like generally carry a meaning of “one or more,” unless stated otherwise.

Furthermore, the terms “approximately”, “approximate”, “about”, and similar terms generally refer to ranges that include the identified value within a margin of 20%, 10%, or preferably 5%, and any values therebetween.

The use of the terms “include”, “includes”, “including,” “have,” “has,” or “having” should be generally understood as open-ended and non-limiting unless specifically stated otherwise.

As used herein, “nanoparticles” are particles having a particle size of 1 nm to 500 nm in at least one aspect within the scope of the present invention. In the present disclosure, the NiMoₓCo₂₋ₓO₄ nanoparticles may be micron sized particles, however they may be made from needles with at least one nanosized dimension as will described later.

As used herein, “particle size” and “pore size” may be thought of as the lengths or longest dimensions of a particle and of a pore opening, respectively.

As used herein, the term “room temperature” refers to a temperature range of “25° C.±3° C. in the present disclosure.

As used herein, the term “electrode” refers to an electrical conductor used to contact a non-metallic part of a circuit, such as a semiconductor, an electrolyte, a vacuum, or air.

As used herein, the term “current density” refers to the amount of electric current traveling per unit cross-section area.

As used herein, the term “Tafel slope” refers to the relationship between the overpotential and the logarithmic current density.

As used herein, the term “electrochemical cell” refers to a device capable of either generating electrical energy from chemical reactions or using electrical energy to cause chemical reactions.

As used herein, the term “water splitting” refers to the chemical reaction in which water is broken down into oxygen and hydrogen.

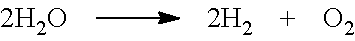

As used herein, the term “overpotential” refers to the difference in potential that exists between a thermodynamically determined reduction potential of a half-reaction and the potential at which the redox event is experimentally observed. The term is directly associated with a cell's voltage efficacy. In an electrolytic cell, the occurrence of overpotential implies that the cell needs more energy as compared to that thermodynamically expected to drive a reaction. The quantity of overpotential is specific to each cell design and varies across cells and operational conditions, even for the same reaction. Overpotential is experimentally measured by determining the potential at which a given current density is reached.

The present disclosure is intended to include all hydration states of a given compound or formula, unless otherwise noted or when heating a material.

In addition, the present disclosure is intended to include all isotopes of atoms occurring in the present compounds and complexes. Isotopes include those atoms having the same atomic number but different mass numbers. By way of general example, and without limitation, isotopes of hydrogen include deuterium and tritium. Isotopes of naturally occurring nickel ²⁸Ni include ⁵⁸Ni, ⁶⁰Ni, ⁶¹Ni, ⁶²Ni, and ⁶⁴Ni. Isotopes of oxygen include ¹⁶O, ¹⁷O, and ¹⁸O and isotopes of cobalt (Co) are ⁵⁶Co, ⁵⁷Co, ⁵⁸Co, and ⁶⁰Co. Isotopically labeled compounds of the disclosure may generally be prepared by conventional techniques known to those skilled in the art or by processes analogous to those described herein, using an appropriate isotopically labeled reagent in place of the non-labeled reagent otherwise employed.

Aspects of the present disclosure are directed to transition metal-doped oxide nanoparticles grown on nickel foam for electrochemical hydrogen production. The present disclosure uses low-metal-cost materials for efficient and durable hydrogen evolution reactions (HER) electrocatalysts.

A method of generating hydrogen is described. The method includes applying a potential of 0.1 to 2.0 volts (V), preferably 0.2-1.9 V, preferably 0.3-1.8 V, preferably 0.4-1.7 V, preferably 0.5-1.6 V, preferably 0.6-1.5 V, preferably 0.7-1.4 V, preferably 0.8-1.3 V, preferably 0.9-1.2 V, and preferably 1.0-1.1 V, to an electrochemical cell. The electrochemical cell includes a counter electrode and an electrocatalyst.

The electrocatalyst further includes a nickel foam substrate and transition metal-doped oxide nanoparticles. In some embodiments, the nickel foam substrate could be replaced with nickel in a form of a sheet or foil, Herein, the foam is used because metal foams with a three-dimensional open-pore structure have a high specific surface area and structural rigidity, and thus are suitable self-supported substrates on which active materials can be in situ grown or coated. In some embodiments, the nickel foam has an average pore size of 500 nm⁻¹ μm, preferably 550-950 nm, preferably 600-900 nm, preferably 650-850, preferably 700-800 nm. In some embodiments, the pores have a circular, rectangular, or square shape.

In alternate embodiments, the substrate may be any metal foam selected from the group consisting of an aluminum foam, a nickel foam, a titanium foam, a titanium alloy foam, an aluminum alloy foam, a magnesium alloy foam, a nickel alloy foam, and a steel foam. The substrate may have a thickness in a range of about 10 micrometers (μm) to 140 μm, for example, ranging from about 20 μm to about 120 μm, from about 50 μm to about 100 μm, from about 70 μm to about 95 μm, or from about 85 μm to about 90 μm, including all ranges and sub-ranges therebetween.

In some embodiments, the transition metal-doped oxide nanoparticles are dispersed on the surface of the substrate using one of the techniques like the drop-casting method, spray coating, spin coating, dip coating, hydrothermal growth, or aerosol-assisted chemical vapor deposition (AACVD). In a preferred embodiment, the transition metal-doped oxide nanoparticles are hydrothermally grown on the nickel foam substrate. The transition metal-doped oxide nanoparticles are distributed on the surface of the nickel foam substrate. The particles cover at least 50%, preferably 55%, preferably 60%, preferably 65%, preferably 70%, preferably 75%, preferably 80%, preferably 85%, preferably 90%, and preferably >95% of the substrate. The transition metal-doped oxide nanoparticles form a continuous layer on the nickel foam substrate, in other words there are no islands formed of the transition metal-doped oxide nanoparticles.

In some embodiments, the transition metal-doped oxide nanoparticles are spinel oxides having a formula of AB₂O₄, where A is at least one of Mn, Cu, Co, Zn, Fe, Ni and B is at least one of Cr, Ni, Mn, Mo, Co. In a preferred embodiment, the transition metal-doped oxide nanoparticles have a formula of NiCo₂O₄ doped with at least one selected from the group consisting of Cr, Ni, Mn, and Mo. In a most preferred embodiment, the transition metal-doped oxide nanoparticles have a formula of NiMoₓCo₂₋ₓO₄, where x is greater than 0.00 and less than or equal to 0.06, preferably 0.02, preferably 0.04, and preferably 0.06.

In some embodiments, the NiMoₓCo₂₋ₓO₄ nanoparticles have a cubic spinel oxide crystal structure. In some embodiments, the crystal structure includes cation occupation of octahedral (Oh) and/or tetrahedral (Td) sites. In some embodiments, the NiMoₓCo₂₋ₓO₄ nanoparticles include Ni(II), Ni(III), Co (II), and Co(III). In some embodiments, 50-80% of the Co and Ni ions occupy octahedral sites, preferably 55-75%, or 60-70%, with the remainder of the Co and Ni occupying tetrahedral sites. In some embodiments, doping with Mo replaces the Co ions at the octahedral sites. In some embodiments, Mo is only present at octahedral sites in the NiMoₓCo₂₋ₓO₄ nanoparticles. In some embodiments, the NiMoₓCo₂₋ₓO₄ nanoparticles have a crystallite size of 12-18 nm, preferably 13-17 nm, and preferably 14-16 nm.

In some embodiments, the NiMoₓCo₂₋ₓO₄ nanoparticles can have morphologies, such as nanowires, nanorods, nanocrystals, nanorectangles, nanotriangles, nanopentagons, nanohexagons, nanoprisms, nanodisks, nanocubes, nanoribbons, nanoblocks, nanobeads, nanotoroids, nanodiscs, nanobarrels, nanogranules, nanowhiskers, nanoflakes, nanofoils, nanopowders, nanoboxes, nanostars, tetrapods, nanobelts, nano-urchins, nanoflowers, etc. and mixtures thereof.

In some embodiments, a first portion of the NiMoₓCo₂₋ₓO₄ nanoparticles have a nano-needle morphology. In some embodiments, the nano-needles, also referred to as the needles, have an average width of 10-30 nm, preferably 15-25 nm, or about 20 nm. In some embodiments, the needles have an average length of 0.5-2.5 μm, preferably 1.0-2.0 μm, or about 1.5 μm. In some embodiments, the needles assemble to form a spherical shape similar to that of a chestnut or a sea urchin, where the needles project horizontally from the sphere. The sphere may have an overall diameter of 1-5 μm, preferably 1.5-4.5 μm, 2.0-4.0 μm, 2.5-3.5 μm, or about 3 μm. In a preferred embodiment, the needles are uniformly spaced to form the sphere and the spacing between the needles forms a porous structure. In some embodiments, the needles are spaced 10-100 nm, preferably 20-90 nm, 30-80 nm, 40-70 nm, or about 50-60 nm apart on an outermost surface of the sphere.

In some embodiments, the NiMoₓCo₂₋ₓO₄ nanoparticles include the first portion having a chestnut shape and a second portion having a different morphology. In some embodiments, the first portion and the second portion are randomly distributed and do not form agglomerations with themselves. In some embodiments, a second portion of the NiMoₓCo₂₋ₓO₄ nanoparticles have a morphology of spheres with an average diameter of 0.1-3 μm, preferably 0.2-2.5 μm, 0.3-2.0 μm, 0.4-1.5 μm, 0.5-1.0 μm, or about 0.6-0.8 μm. In some embodiments, a third portion of the NiMoₓCo₂₋ₓO₄ nanoparticles of randomly distributed needles that do not form a sphere. In some embodiments, the third portion includes needles having a width of 10-100 nm, preferably 20-90 nm, 30-80 nm, 40-70 nm, or about 50-60 nm and a length of 1-5 μm, preferably 1.5-4.5 μm, 2.0-4.0 μm, 2.5-3.5 μm, or about 3 μm.

In alternate embodiments, the second or third portion of the NiMoₓCo₂₋ₓO₄ nanoparticles may have different morphologies, such as microcones, microrods, microcuboidal, micropyramidical, microcylindrical, microwires, microcrystals, microrectangles, microtriangles, microprisms, microdisks, microcubes, microribbons, microblocks, microbeads, microdiscs, microbarrels, microgranules, microwhiskers, microflakes, microfoils, micropowders, microboxes, microstars, microflowers, micropolygonal like trigonal, micropentagonal, microhexagonal, mixtures thereof.

The NiMoₓCo₂₋ₓO₄ nanoparticles include 1-100%, preferably 5-95%, preferably 10-90%, preferably 15-85%, preferably 20-80%, preferably 25-75%, preferably 30-70%, preferably 35-65%, preferably 40-60%, and preferably 45-55% of the first portion based on a total amount of the NiMoₓCo₂₋ₓO₄ nanoparticles. In some embodiments, the NiMoₓCo₂₋ₓO₄ nanoparticles include 1-99%, preferably 5-95%, preferably 10-90%, preferably 15-85%, preferably 20-80%, preferably 25-75%, preferably 30-70%, preferably 35-65%, preferably 40-60%, and preferably 45-55% of the second portion based on a total amount of the NiMoₓCo₂₋ₓO₄ nanoparticles. In some embodiments, NiMoₓCo₂₋ₓO₄ nanoparticles include 1-10% of the third portion, preferably 2-8%, 3-7%, or 4-6%, based on a total amount of the NiMoₓCo₂₋ₓO₄ nanoparticles.

In some embodiments, the counter electrode includes at least one of graphite and platinum. In alternate embodiments, the counter electrode is made from a material selected from the group consisting of platinum, gold, and carbon. In alternate embodiments, the counter electrode may contain an electrically-conductive material such as platinum, platinum-iridium alloy, iridium, titanium, titanium alloy, stainless steel, gold, cobalt alloy, and/or some other electrically-conductive material, where an “electrically-conductive material” as defined here is a substance with an electrical resistivity of at most 10⁻⁶ Ω·m, preferably at most 10⁻⁷ Ω·m, more preferably at most 10⁻⁸ Ω·m at a temperature of 20-25° C. The form of the counter electrode may be generally relevant only in that it needs to supply sufficient current to the electrolyte solution to support the current required for the electrochemical reaction of interest. The counter electrode material should thus be sufficiently inert to withstand the chemical conditions in the electrolyte solution, such as acidic or basic pH values, without substantially degrading during the electrochemical reaction. The counter electrode should preferably not leach out any chemical substance that interferes with the electrochemical reaction or might lead to undesirable electrode contamination. In a preferred embodiment, the counter electrode is graphite.

In one embodiment, the electrochemical cell further includes a reference electrode in contact with the electrolyte solution. A reference electrode is an electrode that has a stable and well-known electrode potential. The high stability of the electrode potential is usually reached by employing a redox system with constant (buffered or saturated) concentrations of each relevant species of the redox reaction. A reference electrode may enable a potentiostat to deliver a stable voltage to the working electrode (which herein is the electrocatalyst) or the counter electrode. The reference electrode may be a standard hydrogen electrode (SHE), a normal hydrogen electrode (NHE), a reversible hydrogen electrode (RHE), a saturated calomel electrode (SCE), a copper-copper(II) sulfate electrode (CSE), a silver chloride electrode (Ag/AgCl), a pH-electrode, a palladium-hydrogen electrode, a dynamic hydrogen electrode (DHE), a mercury-mercurous sulfate electrode, mercury/mercuric oxide (Hg/HgO) electrode, or some other type of electrode. In a preferred embodiment, a reference electrode is an Ag/AgCl electrode. However, in some embodiments, the electrochemical cell does not include a third electrode.

In some embodiments, the electrochemical cell is at least partially submerged in an electrolyte, preferably 50%, preferably 60%, or more preferably at least 70%. In some embodiments, the aqueous solution includes water and a base. The water may be tap water, distilled water, bidistilled water, deionized water, deionized distilled water, reverse osmosis water, and/or some other water. In some embodiments, the electrolyte includes the aqueous solution of the base at a concentration of 0.05-0.5 M, preferably 0.1-0.45 M, preferably 0.15-0.4 M, preferably 0.2-0.35 M, and preferably 0.25-0.3 M. In a preferred embodiment, the electrolyte includes the aqueous solution of a base at a concentration of 1 M. In some embodiments, the base is at least one selected from the group consisting of sodium hydroxide (NaOH), potassium hydroxide (KOH), lithium hydroxide (LiOH), barium hydroxide (Ba(OH)₂), calcium hydroxide (Ca(OH)₂). In an alternative embodiment, an organic base may be used, such as sodium acetate and potassium acetate. In a preferred embodiment, the base is KOH. Preferably, to maintain uniform concentrations and/or temperatures of the electrolyte solution, the electrolyte solution may be stirred or agitated during the step of the subjecting. The stirring or agitating may be done intermittently or continuously. This stirring or agitating may be done by a magnetic stir bar, a stirring rod, an impeller, a shaking platform, a pump, a sonicator, a gas bubbler, or some other device. Preferably, the stirring is done by an impeller or a magnetic stir bar.

Preferably, the electrocatalyst functions as the cathode, receiving a negative potential to reduce H₂O into H₂ gas and OH⁻, while the counter electrode functions as the anode, receiving a positive potential to oxidize OH⁻ into O₂ gas. This is summarized by the following reactions:

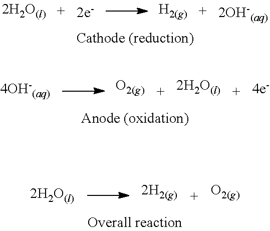

In some embodiments, the working electrode and the counter-electrode are connected to each other by way of electrical interconnects that allow for the passage of current between the electrodes, when a potential is applied between them. In one embodiment, the potential may be applied to the electrodes by a battery, such as a battery including one or more electrochemical cells of alkaline, lithium, lithium-ion, nickel-cadmium, nickel metal hydride, zinc-air, silver oxide, and/or carbon-zinc. In another embodiment, the potential may be applied through a potentiostat or some other source of direct current, such as a photovoltaic cell. In one embodiment, a potentiostat may be powered by an AC adaptor, which is plugged into a standard building or home electric utility line. In one embodiment, the potentiostat may connect with a reference electrode in the electrolyte solution. Preferably the potentiostat is able to supply a relatively stable voltage or potential. For example, in one embodiment, the electrochemical cell is subjected to a voltage that does not vary by more than 5%, preferably by no more than 3%, preferably by no more than 1.5% of an average value throughout the subjecting. In another embodiment, the voltage may be modulated, such as being increased or decreased linearly, being applied as pulses, or being applied with an alternating current.

In one embodiment, the method further comprises the step of separately collecting H₂-enriched gas and O₂-enriched gas. In one embodiment, the space above each electrode may be confined to a vessel in order to receive or store the evolved gases from one or both electrodes. The collected gas may be further processed, filtered, or compressed. Preferably the H₂-enriched gas is collected above the cathode, and the O₂-enriched gas is collected above the anode. The electrolytic cell, or an attachment, may be shaped so that the headspace above the electrocatalyst is kept separate from the headspace above the reference electrode. In one embodiment, the H₂-enriched gas and the O₂-enriched gas are not 100 vol % H₂ and 100 vol % O₂, respectively. For example, the enriched gases may also comprise N₂ from the air, water vapor, and other dissolved gases from the electrolyte solution. The H₂-enriched gas may also comprise O₂ from the air. The H₂-enriched gas may comprise greater than 20 vol % H₂, preferably greater than 40 vol % H₂, more preferably greater than 60 vol % H₂, and even more preferably greater than 80 vol % H₂, relative to a total volume of the receptacle collecting the evolved H₂ gas. The O₂-enriched gas may include greater than 20 vol % O₂, preferably greater than 40 vol % O₂, more preferably greater than 60 vol % O₂, and even more preferably greater than 80 vol % O₂, relative to a total volume of the receptacle collecting the evolved O₂ gas. In some embodiments, the evolved gases may be bubbled into a vessel comprising water or some other liquid, and higher concentrations of O₂ or H₂ may be collected. In one embodiment, evolved O₂ and H₂, or H₂-enriched gas and O₂-enriched gas, may be collected in the same vessel.

In some embodiments, the electrocatalyst has an electrochemically active surface area (ECSA) of 12-22 centimeter square (cm²), preferably 13-21 cm², preferably 14-20 cm², preferably 15-19 cm², and preferably 16-18 cm².

In some embodiments, the electrocatalyst has a Tafel slope of 60-115 millivolt/decade (mVdec⁻¹), preferably 65-110 mVdec⁻¹, preferably 70-105 mVdec⁻¹, preferably 75-100 mVdec⁻¹, preferably 80-95 mVdec⁻¹, and preferably 85-90 mVdec⁻¹. In some embodiments, for NiMoₓCo₂₋ₓO₄ (x=0.04), the electrocatalyst has a Tafel slope of 60-65 mVdec⁻¹, preferably 61-64 mVdec⁻¹, and preferably 62-63 mVdec⁻¹. In a preferred embodiment, the electrocatalyst has a Tafel slope of 61.9 mVdec⁻¹ for NiMoₓCo₂₋ₓO₄ (x=0.04).

In some embodiments, the electrocatalyst has an overpotential of 200-300 mV, preferably 210-290 mV, preferably 220-280 mV, preferably 230-270 mV, and preferably 240-260 at 10 mA/cm². In some embodiments, for NiMoₓCo₂₋ₓO₄ (x=0.04), the electrocatalyst has an overpotential of 220-230 mV at 10 mA/cm², preferably 221-229 mV, preferably 222-228 mV, preferably 223-227 mV, and preferably 224-226 mV at 10 mA/cm².

While not wishing to be bound to a single theory, it is thought that the introduction of Mo altered the electron distribution and impeded the surface oxidation of the NiCo₂O₄, leading to an increase in the availability of active sites and ultimately promoting the efficacy of the HER process. However, if there is an overabundance of Mo doping in NiCo₂O₄, the Mo hinders the active sites and functions as a recombination center due to alterations in structure and composition.

### EXAMPLES

The following examples demonstrate a method of generating hydrogen. The examples are provided solely for illustration and are not to be construed as limitations of the present disclosure, as many variations thereof are possible without departing from the spirit and scope of the present disclosure.

### Example 1: Materials

The chemicals used were analytical grade and utilized with no additional purification. Nickel nitrate (Ni(NO₃)₂·6H₂O, 98%), ammonium molybdate ((NH₄)₆Mo₇O₂₄·4H₂O, 99%), cobalt (II) nitrate (Co(NO₃)₂·6H₂O, 98%), urea (CO(NH₂)₂) were obtained from Sigma-Aldrich and the nickel foam (NF).

### Example 2: Synthesis of Mo-doped NiCo₂O₄ CNSPs

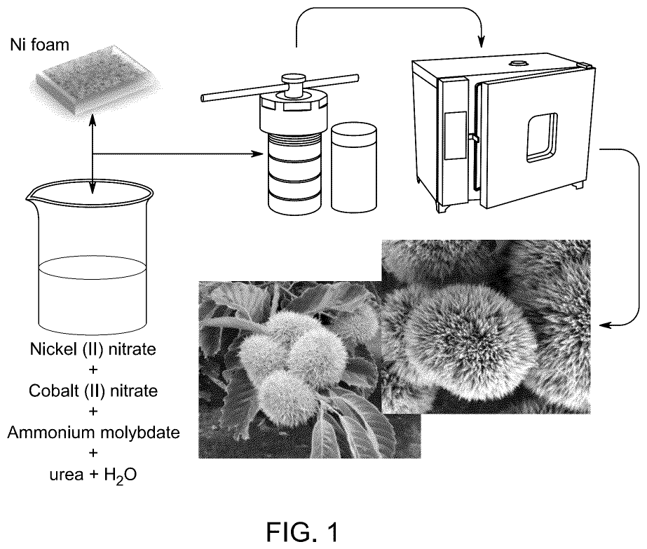

Referring to FIG. 1C, a schematic illustration of the synthesis of three dimensional (3D) NiMoₓCo₂₋ₓO₄ (x≤0.06) CNSPs grown on NF. The 3D NiMoₓCo₂₋ₓO₄ (x≤0.06) CNSPs grown on NF were synthesized hydrothermally. Samples were synthesized for the NiMoₓCo₂₋ₓO₄, where x=0.00, 0.02, 0.04, and 0.06. The amounts of the components in the synthetic method were varied based on the desired composition.

Initially, the NF sheet was segregated into pieces of size 5×5 cm² and cleaned in an ultrasonic bath for 10 minutes (min) using 3 molar (M) hydrochloric acid (HCl). Subsequently, ethanol and deionized (DI) water were used to separate the nickel oxide from the NF surface. For growing CNSPs on NF, nickel nitrate (98%), cobalt (II) nitrate (98%), ammonium molybdate (99%) were mixed with 3 milli-molar (mM) urea, 40 milliliters (mL) DI water and stirred for 20 min. Further, the solution was transferred to a 50 mL Teflon-lined stainless-steel autoclave. Concurrently, a piece of NF was directly immersed into the mixture in the Teflon and heated at 120° C. for 8 hours. In addition, the autoclave was chilled at room temperature (RT). The NF was cleaned with ethanol, assembled with residual powder, washed with DI water, collected, and dried at 50° C. overnight. Furthermore, the powder was calcinated at 350° C. in a furnace for 3 hours to produce the 3D NiMoₓCo₂₋ₓO₄ (x≤0.06) CNSPs grown on Ni foam.

### Example 3: Characterization Techniques

Lattice structural information of NiMoₓCo₂₋ₓO₄ (x≤0.06) CNSPs phase was investigated using X-ray diffraction (XRD) with a Rigaku X-ray diffractometer, at a wavelength (λ) of about 1.54059 angstrom (Å). Morphology, including shape and particle size of NiMoₓCo₂₋ₓO₄ CNSPs, was examined by field emission scanning electron microscopy (FESEM), transmission electron microscopy (TEM), and high-resolution transmission electron microscopy (HRTEM). Chemical compositions and oxidation states of the elements in NiMoₓCo₂₋ₓO₄ CNSPs were studied using X-ray photoelectron spectroscopy (XPS) instruments. First-principles calculations were made using density functional theory (DFT)-based Quantum ATK software.

### Example 4: Electrochemical Procedure

Electrocatalytic activity of NiMoₓCo₂₋ₓO₄ (x≤0.06) CNSPs electrodes for hydrogen evolution reaction (HER) was evaluated using a computer-controlled potentiostat (Metrohm AutoLab PGSTAT302N) in a conventional three-electrode chemical cell containing 1M potassium hydroxide (KOH) electrolyte with a pH of 13.6. The NF electrodes, having a size of about 1×1 cm², were subjected to modification for the working electrode. In addition, the chemical cell employed Ag/AgCl 3.5 M potassium chloride (KCl) solution as the reference electrode, and graphite as the counter electrode. Before conducting the electrochemical measurements, the electrolytes were bubbled with nitrogen gas for a minimum duration of 30 min.

The catalytic efficacy of the electrodes was assessed through linear sweep voltammetry (LSV) at a scan rate of 10 millivolts per second mV/s in a 1 M KOH solution. The voltage that was measured, underwent an adaptation process to conform to the reversible hydrogen electrode (RHE) through the utilization of a formula as follows:

$${E}_{RHE} = {E}_{applied} + 0.0591 \times pH + {E}_{Ag / AgCl}$$

Further, Tafel slopes were computed utilizing the Tafel equation:

$$η = a + b log ( j )$$

where ‘a’ is the Tafel constant, ‘b’ is the Tafel slope, ‘j’ is the current density, and ‘f’ is the overpotential. Electrochemical impedance spectroscopy (EIS) measurements were also conducted within a frequency range of 10⁻¹ hertz (Hz) to 105 Hz, utilizing a potentiostat (Autolab: PGSTAT302N) equipped with a FRA32 M module. A constant amplitude of 10 mV was maintained throughout the EIS. Electrochemically active surface area (ECSA) of the electrodes, representative of the sample, was determined through the measurement of cyclic voltammetry (CV) in a non-faradic region of 0.21 to 0.31 Vs. RHE at varying scan rates of 40 mV/s, 60 mV/s, 80 mV/s, 100 mV/s, and 120 mV/s. Further, electrochemical double-layer capacitance (C_{dl}) was estimated by plotting the difference in current density variation (Δj=jₐ−j_{c}) at an applied potential of 0.26 vs. RHE against the scan rate. The ECSA, measured in cm², was subsequently calculated using the obtained C_{dl} value. In an aspect of the present disclosure, the ECSA of the representative electrodes was assessed using the following formula:

$$E C S A = {C}_{dl} / {C}_{S}$$

where Cₛ denotes specific capacitance ranging from 20 microfarads per square centimeter (μF/cm²) to 60 μF/cm². In another aspect of the present disclosure, a specific capacitance of 40 μF/cm² was selected as the average value. Calculation of the roughness factor was performed utilizing the following formula:

$$RF = E C S A / {A}_{geomatric}$$

The calculation of the specific activity (SA in mA/cm²) was performed through the utilization of ECSA, employing the equation SA=j/ECSA, where j represents the cathodic current at an overpotential of 300 mV. The surface-active sites (n) of the electrodes depicted were assessed by conducting CV at a scan rate of 40 mV/s in 1M KOH electrolyte solution. To determine the surface charge density (Qs), the integrated charge of each electrode was divided in half, under an assumption of a one-electron redox process. The computation of the value of n was calculated using the following equation:

$$n = Qs / F$$

Chronopotentiometry (CP) analyses were conducted to evaluate its stability and durability, utilizing current densities of 10 mA/cm².

### Example 5: Structural Characterization

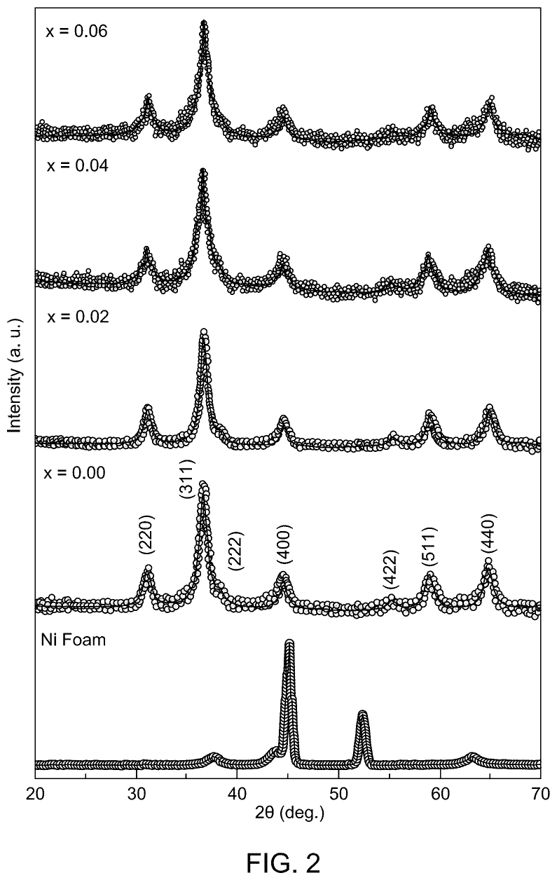

To analyze the phase formation of 3D NiMoₓCo₂₋ₓO₄ (x≤0.06) CNSPs grown on Ni foam, an X-ray powder pattern was employed, as shown in FIG. 2. As can be seen from FIG. 2, the phase formation exhibited the formation of pure cubic spinel oxide structure without undesired phases corresponding to JCPDS card no. 20-0781. The XRD displayed the structure of the NF substrate according to JCPDS card no. 04-0850. Further, the spectrum showed a broadened peak representing a small crystal size. The lattice parameters such as a=d(h²+k²+l²)^{1/2}), cell volume (V), crystal size (D_{XRD}) (D_{XRD}=Kλ/β cos θ), weighted-profile R-factor (R_{wp}), expected R-factor (Rₑₓₚ), chi-squared values (χ²=(R_{wp}/Rₑₓₚ)²) and R_{Brag}, indicates goodness of fit between theoretical calculation and the experimental data. All parameters were computed using the Rietveld refinement method via Match3!linked with full-proof software, the results are cataloged in Table 1. Furthermore, structural parameters and cell volume increased with the increase in the amount of Mo due to the expansion of spinel structure caused by the difference of ionic radii between the dopant (Mo) and the host ion (Co). As can be seen from Table 1, the crystal size is within a range of 12 nm to 18 nm. Moreover, FIG. 2 depicted the XRD pattern of modified NF that showed the peaks around 440 and 52.5°, while the peaks around 37°, 43°, and 640 are relevant to planes 311, 400, and 440, respectively.

The cation distribution in the NiMoₓCo₂₋ₓO₄ CNSPs system was analyzed using the Bertaut method. The method involved using intensity ratios from specific crystallographic planes in the XRD pattern, specifically I₂₂₀/I₄₄₀ and I₄₂₂/I₄₀₀, due to their sensitivity to cation placement. The detailed cation distribution for the NiMoₓCo₂₋ₓO₄ CNSPs system is depicted in Table 1. This analysis indicated that Co and Ni ions exist in both divalent and trivalent states, contributing to the stoichiometric balance of the system. Predominantly, Co and Ni ions occupied octahedral sites, with about 60% of Ni ions located at the octahedral B sites and the remaining 40% at tetrahedral A sites. The introduction of Mo ions decreased the proportion of Co ions at the octahedral B sites. As rare-earth elements with larger ionic radii, Mo ions were exclusively found at the octahedral B-sites.

TABLE 1
Structural parameters and cation distribution of
NiMoxCo2-xO4 (x ≤ 0.06) CNSPs.

| | | | DXRD | | | | |
|---|---|---|---|---|---|---|---|
| X | a(Å) | V(Å3) | (nm) ± 0.03 | χ² | R_{Bragg} | Tetrahedral (Td) A-site | Octahedral (Oh) B-site |
| 0.00 | 8.1302 | 537.4155 | 14.80 | 1.2 | 8.10 | Ni_{0.4}Co_{0.6} | Ni_{0.6}Co_{1.4} |
| 0.02 | 8.1348 | 538.3122 | 12.80 | 1.4 | 7.60 | Ni_{0.4}Co_{0.6} | Ni_{0.6}Mo_{0.02}Co_{1.38} |
| 0.04 | 8.1362 | 538.5901 | 16.10 | 1.4 | 12.70 | Ni_{0.4}Co_{0.6} | Ni_{0.6}Mo_{0.04}Co_{1.36} |
| 0.06 | 8.1448 | 540.3058 | 17.50 | 1.3 | 12.60 | Ni_{0.4}Co_{0.6} | Ni_{0.6}Mo_{0.06}Co_{1.34} |

### Example 6: Morphological Characterization

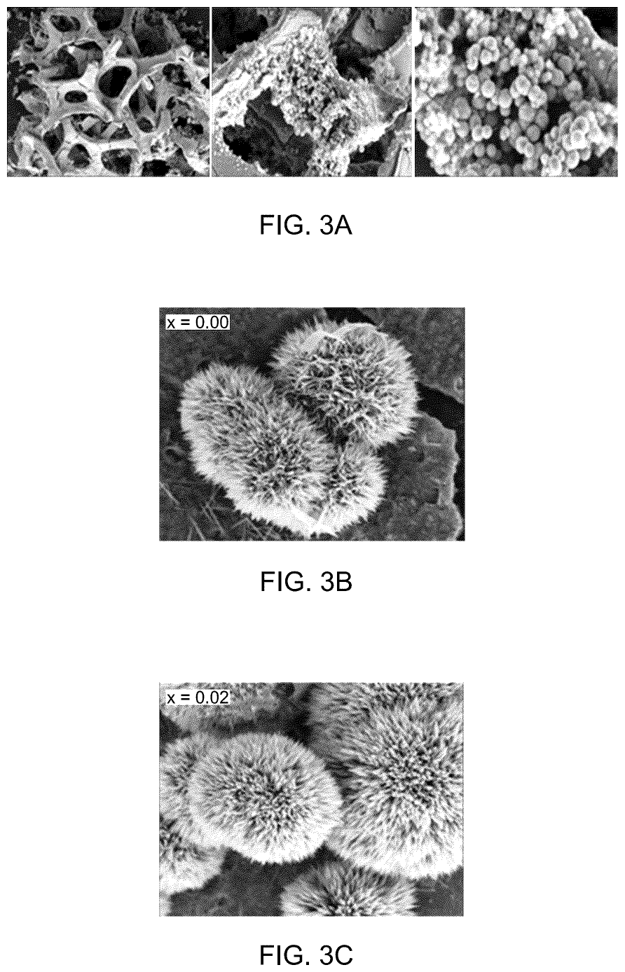

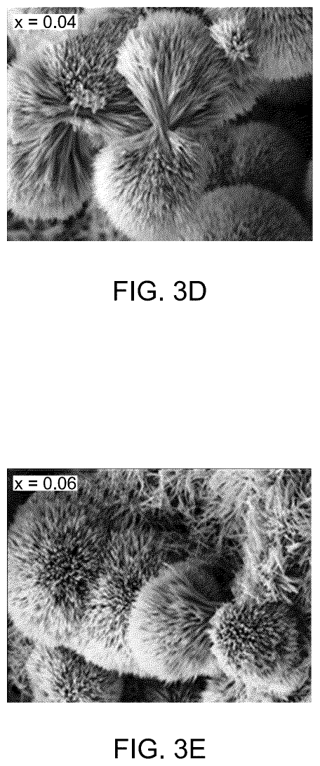

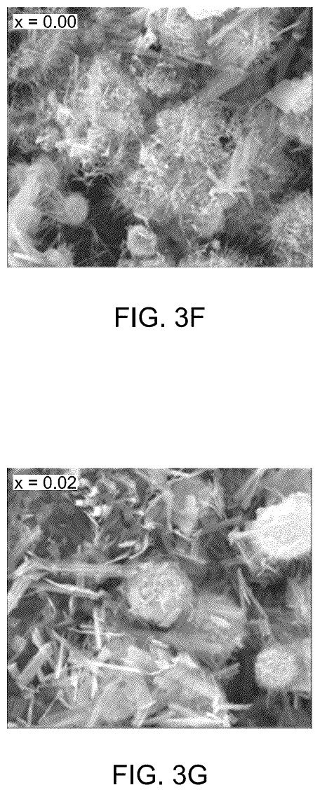

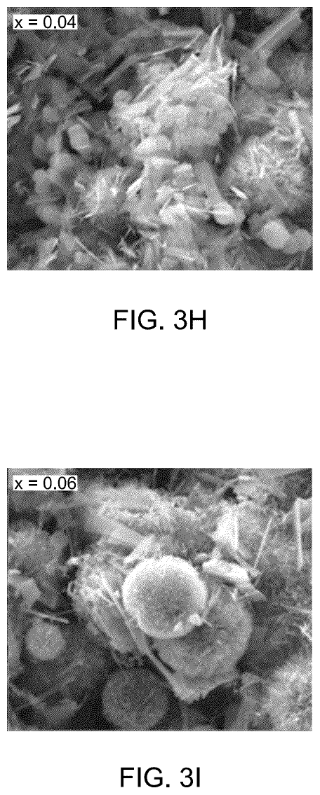

FESEM and scanning electron microscopy (SEM) were utilized to analyze the surface morphology of prepared electrocatalysts. FIGS. 3A-3I are FESEM images of NiMoₓCo₂₋ₓO₄ CNSPs grown on NF at different magnifications 3D NiMoₓCo₂₋ₓO₄ (x≤0.06) CNSPs grown on NF and as-synthesized microsphere particles.

FIG. 3A provides different magnification images for the microspheres grown on the NF. The images show the microsphere particles covering the entire NF substrate. FIGS. 3B-3E show SEM images of NiMoₓCo₂₋ₓO₄ (x=0.00, 0.02, 0.04, 0.06) CNSPs grown on NF, respectively. The microsphere particles are composed of lengthy, thin, and steep tips nanoneedles with a diameter of around 20 nm. The nanoneedles grow horizontally from the center, which positively affects the electrode performances. Furthermore, FIGS. 3F-3I illustrate the SEM images of the of NiMoₓCo₂₋ₓO₄ (x=0.00, 0.02, 0.04, 0.06) CNSPs microspheres obtained after washing the NF. The samples include groups of microsphere particles interspersed with some chestnut-like particles.

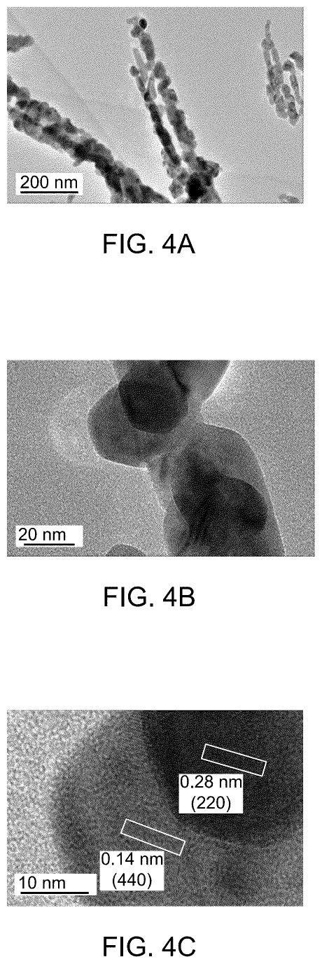

Moreover, TEM analysis of NiMoₓCo₂₋ₓO₄ (x=0.04) CNSPs was performed. FIG. 4A-4B are TEM images of NiMoₓCo₂₋ₓO₄ (x=0.04) CNSPs grown on NF at 200 nm and 20 nm magnification. The TEM illustrates that the nano-needles shape includes uniform distribution of nano-needles, which leads to the creation of porous chestnut-like structures. The HR-TEM image in FIG. 4C revealed lattice spacing that was calculated via GATAN software confirming the spinel oxide structure.

### Example 7: XPS Analysis

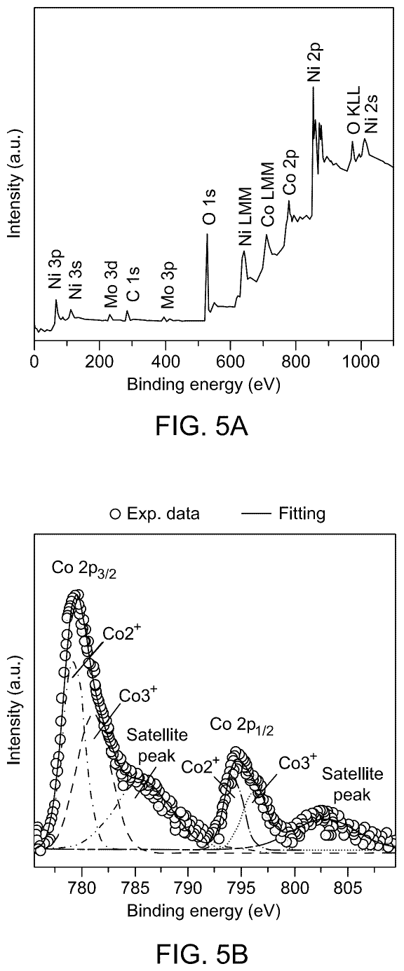

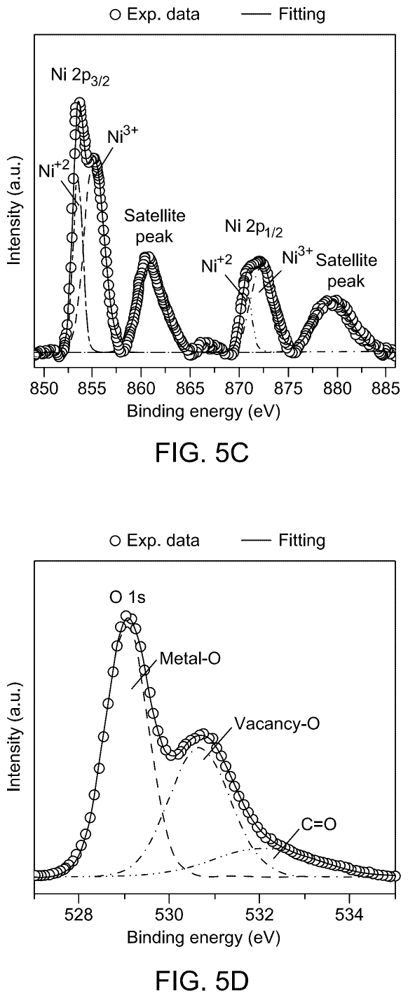

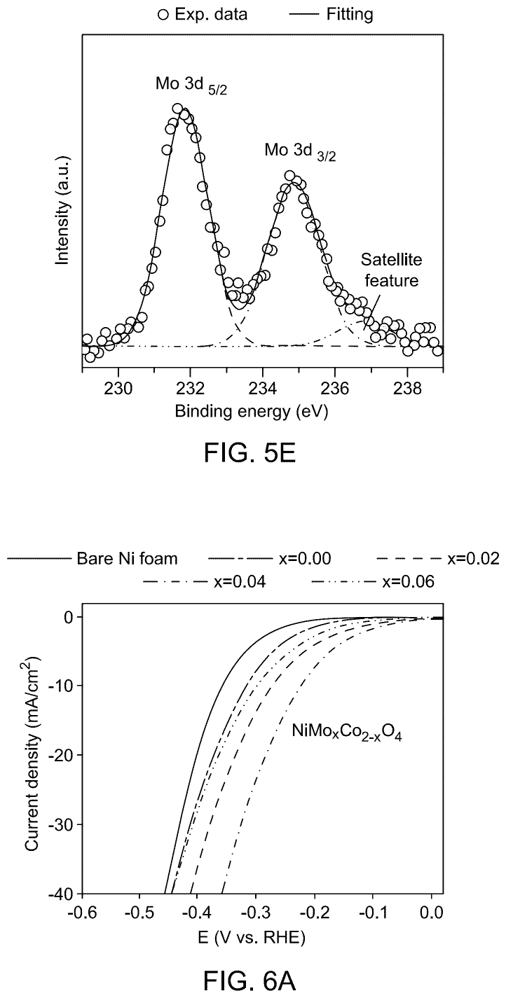

The chemical composition and ionic state of constituent elements in the sample NiMoₓCo₂₋ₓO₄ (x=0.04) CNSPs were studied using XPS, as shown in FIGS. 5A-5E. All elements in the sample are identified over a broad energy spectrum and indexed appropriately in the survey scan, as shown in FIG. 5A. FIG. 5B shows the core spectra of Co 2p spin-orbit doublets were detected at 779.5 eV for 2p_{3/2} and 794.5 eV for 2p_{1/2}, along with two satellite peaks at 785.6 eV and 802.9 eV, respectively. The deconvolution of Co 2p_{3/2} and Co 2p_{1/2} spectrum was performed to get two peaks in each case that were assigned to Co²⁺ and Co³⁺ states. The peaks positioned at 779.2 eV and 794.2 eV were referred to as the Co²⁺ state, whereas the peaks situated at 781.1 eV and 796.1 eV were referred to as the Co³⁺ state. The slight deviation of Co 2p_{3/2} and Co 2p_{1/2} peak intensities from 2:1 was attributed to the overlapping of auger peak Co L₃M₄₅M₄₅ caused by using Al Kα X-ray source.

Further, FIG. 5C illustrates the core spectra of Ni 2p with spin-orbit splitting of 17.9 eV, along with two satellite peaks at 860.9 eV and 879.5 eV. The deconvoluted Ni 2p_{3/2} spectrum introduced two characteristic peaks at 853.6 eV and 855.1 eV, assigned to Ni²⁺ and Ni³⁺ states, respectively. Similarly, two characteristic peaks were obtained through the deconvolution of the Ni 2p_{1/2} spectrum at 870.7 eV and 872.2 eV, corresponding to Ni²⁺ and Ni³⁺ states. A broad peak of the 0 is spectrum, as shown in FIG. 5D, was detected at 529.0 eV, which was fitted using three peaks. The peaks obtained at 529.0 eV, 530.6 eV, and 532.1 eV were assigned to covalently bonded oxygen in cobaltite (metal-O), oxygen vacancy/defects (vacancy-O), and atmospheric oxygen in the form of organic contaminations (C═O), respectively. Mo 3d spectra were detected with well-defined splitting of 3d_{5/2} and 3d_{3/2} components having Δ_{BE}=3.1 eV, as shown in FIG. 5E. The core level peaks observed at 231.8 eV and 234.9 eV were attributed to the Mo 3d_{5/2} and Mo 3d_{3/2} spin-orbit doublet states indicated to Mo⁶⁺, which indicated that Mo substituted into the NiCo₂O₄ successfully.

### Example 8: Electrochemical HER Performance

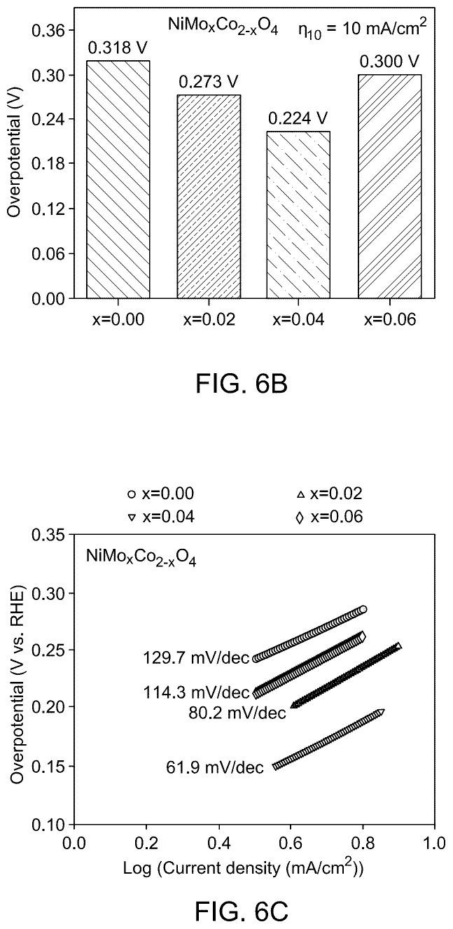

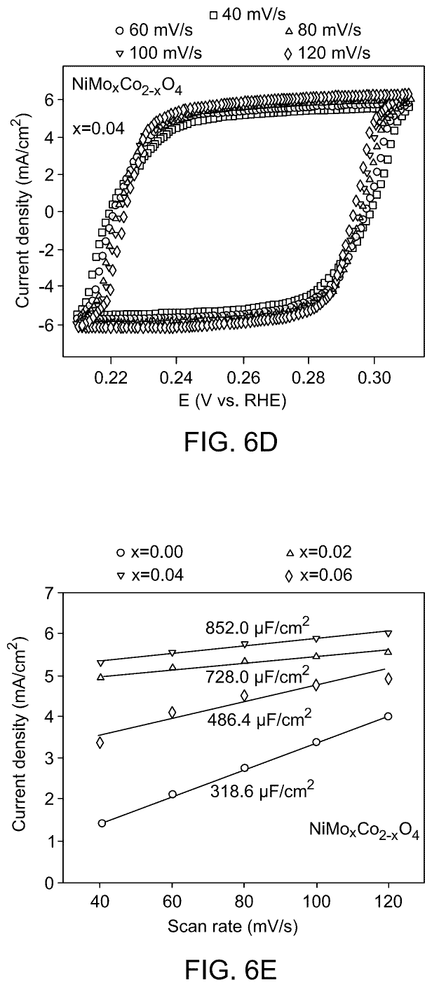

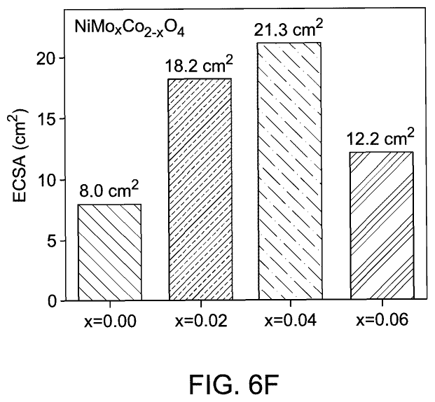

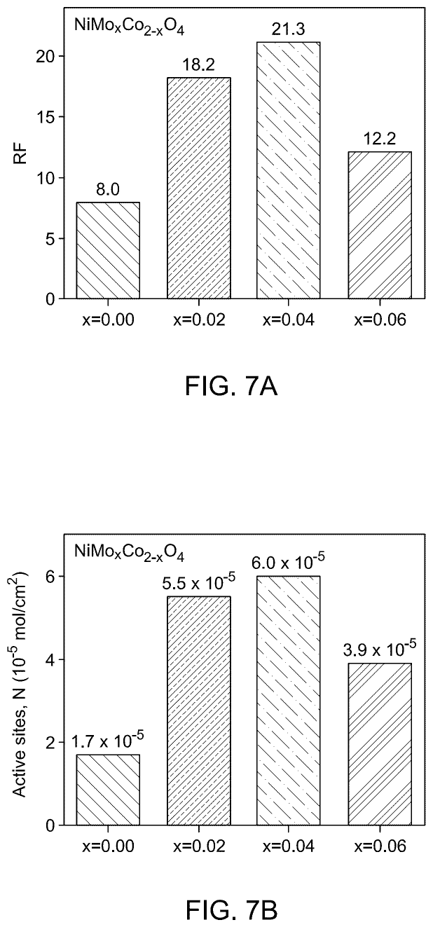

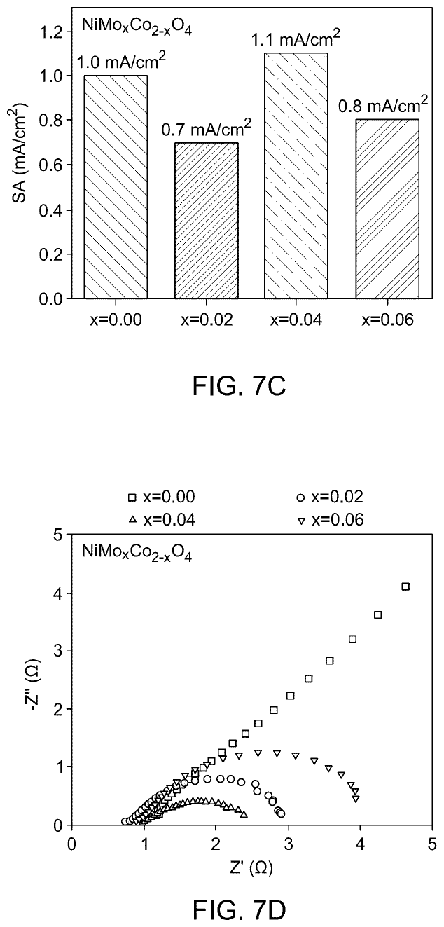

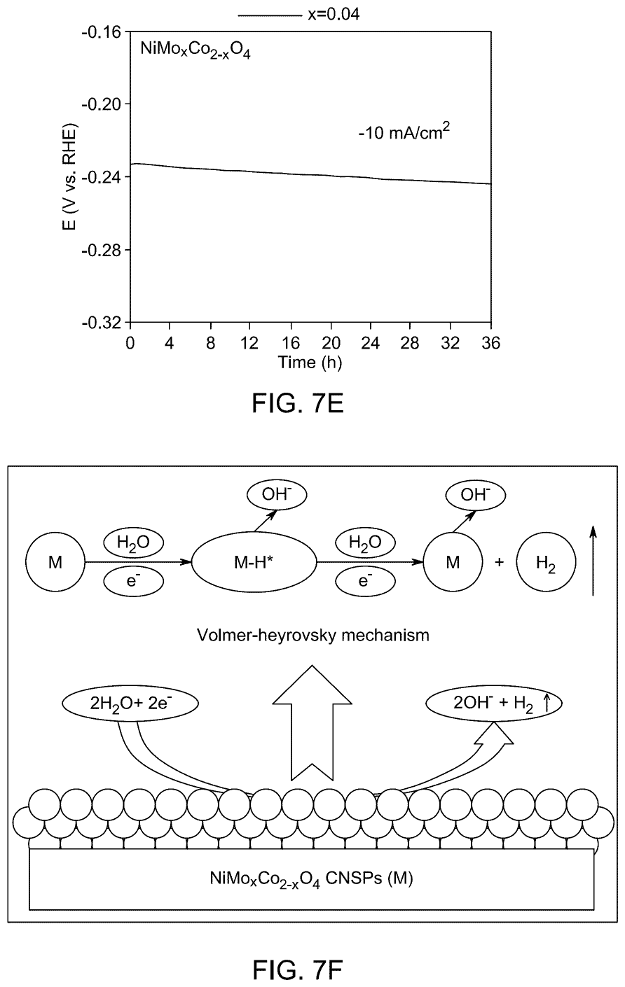

The electrochemical efficacy of NiMoₓCo₂₋ₓO₄ (x≤0.06) CNSPs electrocatalyst, modified using representative NF conducting substrates, was assessed through LSV and CP using a three-electrode system in N₂-saturated 1M KOH solution with a pH of 13.6, as shown in FIGS. 6A-6F and FIGS. 7A-7F. The catalytic activity of the NF electrode alone was high. The LSV curves were acquired utilizing a 10 mV/s scan rate, as illustrated in FIG. 6A. However, upon modification of the NF electrode with NiCo₂O₄ (x=0.00), the current density was further improved and attained a value of 0.318 V vs RHE when subjected to an overpotential at current density (−10 mA/cm²). Further, the catalytic efficacy experienced a notable enhancement after introducing Mo into the Co sites within NiCo₂O₄, leading to the formation of NiMoₓCo₂₋ₓO₄ CNSPs. Introducing Mo⁶⁺ into the NiCo₂O₄ framework modulated the electronic configuration of Co within the framework, thereby augmenting the HER efficacy through its function as a catalytic center and amplifying the collective catalytic active sites. The NiMoₓCo₂₋ₓO₄ (where x=0.04) CNSPs display superior catalytic activity for the HER process, requiring a low overpotential of 0.224 V to achieve a current density of −10 mA/cm², as illustrated in FIG. 6B.

The kinetics of hydrogen evolution on electrodes composed of bare and Mo-doped NiCo₂O₄ CNSPs were further analyzed using Tafel slopes. The Tafel slopes were quantified through utilization of a linear regression model applied to the Tafel plot, which plots the overpotential against the logarithm of current density. The Tafel slope of the 4% Mo-doped NiCo₂O₄ CNSPs electrode is 61.9 mV/dec, as depicted in FIG. 6C. The Tafel slope increased in the NiCo₂O₄ electrodes doped with 6% Mo. This may be due to the inhibition of active sites, which may agree with the LSV curves depicted in FIG. 6A. Table 2 provides a comparison of the electrocatalyst as described in the present disclosure and other electrocatalysts in alkaline environments.

TABLE 2
Comparison of electrochemical HER performance over some reported
electrocatalysts in alkaline (1M KOH) electrolytes.

| | | Overpotential | Tafel | | |
|---|---|---|---|---|---|
| | | (mV at 10 | Slope | Stability | |
| Catalyst | Substrate | mA/cm²) | (mV/dec) | (h) | Ref |
| NiMoₓCo₂₋ₓO₄ | NF | 224 | 61.9 | 36 | * |
| (x = 0.04) | GC | 529 | 109.2 | | |
| MS—CS NTs | GC | 220 | 89 | 25 | [1] |
| MoS₂@Mo—S—C₃N₄ | GC | 290 | 146 | 2 | [2] |
| Co₂B-500/NG | GC | 380 | 45 | 60 | [3] |
| CoOₓ@CN | GC | 232 | 82 | 2 | [4] |
| EG/Co_{0.85}Se/ | GC | ~265 | 160 | 4 | [5] |
| NiFe—LDH | | | | | |
| NiCoFeB | GC | 345 | 98 | 10 | [6] |
| Ni(OH)₂/MoS₂ | GC | 227 | 105 | — | [7] |
| Ni₃S₂ | NF | 223 | 123.3 | — | [8] |
| Ni/NiS | NF | 230 | 123.3 | 24 | [9] |
| Ni₃S₂@TiO₂ | NF | 190 | 102.3 | — | [10] |
| Ni₃S₂—MoS₂ | NF | 164 | 98.2 | 200 | [10] |

NF = Nickel foam;
GC = Glassy carbon electrode;
* = present disclosure
[1] X. Wang, B. Zheng, B. Yu, B. Wang, W. Hou, W. Zhang, Y. Chen, In situ synthesis of hierarchical MoSe₂—CoSe₂ nanotubes as an efficient electrocatalyst for the hydrogen evolution reaction in both acidic and alkaline media.
[2] B. Zhang, J. Li, Q. Song, X. Xu, W. Hou, H. Liu, Transferable active centres of strongly coupled MoS₂@ sulfur and molybdenum co-doped g-C₃N₄ heterostructure electrocatalysts for boosting hydrogen evolution reaction in both acidic and alkaline media.
[3] J. Masa, P. Weide, D. Peeters, I. Sinev, W. Xia, Z. Sun, C. Somsen, M. Muhler, W. Schuhmann, Amorphous cobalt boride (Co₂B) as a highly efficient nonprecious catalyst for electrochemical water splitting: oxygen and hydrogen evolution.
[4] H. Jin, J. Wang, D. Su, Z. Wei, Z. Pang, Y. Wang, In situ cobalt-cobalt oxide/N-doped carbon hybrids as superior bifunctional electrocatalysts for hydrogen and oxygen evolution.
[5] Y. Hou, M. R. Lohe, J. Zhang, S. Liu, X. Zhuang, X. Feng, Vertically oriented cobalt selenide/NiFe layered-double-hydroxide nanosheets supported on exfoliated graphene foil: an efficient 3D electrode for overall water splitting.
[6] Y. Li, B. Huang, Y. Sun, M. Luo, Y. Yang, Y. Qin, L. Wang, C. Li, F. Lv, W. Zhang, Multimetal borides nanochains as efficient electrocatalysts for overall water splitting
[7] G. Zhao, Y. Lin, K. Rui, Q. Zhou, Y. Chen, S. X. Dou, W. Sun, Epitaxial growth of Ni(OH)₂ nanoclusters on MoS₂ nanosheets for enhanced alkaline hydrogen evolution reaction.
[8] L.-L. Feng, G. Yu, Y. Wu, G.-D. Li, H. Li, Y. Sun, T. Asefa, W. Chen, X. Zou, High-index faceted Ni₃S₂ nanosheet arrays as highly active and ultra stable electrocatalysts for water splitting.
[9] G. Chen, T. Y. Ma, Z. Liu, N. Li, Y. Su, K. Davey, S. Qiao, Efficient and stable bifunctional electrocatalysts Ni/NiₓM_{y} (M = P, S) for overall water splitting.
[10] D. Guo, Z. Wan, G. Fang, M. Zhu, B. Xi, A Tandem Interfaced (Ni₃S₂—MoS₂)@TiO₂ composite fabricated by atomic layer deposition as efficient HER Electrocatalyst.

Further, an analysis was conducted on the ECSA to examine the inherent HER performance of both unmodified and Mo-doped NiCo₂O₄ CNSPs composite electrodes. The calculation of the ECSA involved the evaluation of the C_{dl}, which was determined by measuring the CV at varying scan rates within a non-faradic region, as depicted in FIG. 6D. Furthermore, as shown in FIG. 6E, the electrode denoted as NiMoₓCo₂₋ₓO₄ (x=0.04) CNSPs demonstrated the highest C_{dl} value of 852.0 μF/cm² compared to other electrodes of the same type. The observed C_{dl} value exhibits an increase of nearly 2.7 times compared to the unmodified NiCo₂O₄ electrode, thus indicating the influence of Mo doping on the NiCo₂O₄ CNSPs framework on Ni foam.

The NiMoₓCo₂₋ₓO₄ (x=0.04) CNSPs electrode displayed a notably greater ECSA of 21.3 cm² in comparison to both unmodified (8.0 cm²) and alternative Mo-doped NiCo₂O₄ electrodes. The ECSA histogram is depicted in FIG. 6F and indicates that introducing Mo doping in the NiMoₓCo₂₋ₓO₄ CNSPs electrode results in a considerable increase in ECSA compared to the unmodified NiCo₂O₄ electrode. The introduction of Mo doping altered the electron distribution and impeded the surface oxidation of NiCo₂O₄, leading to an increase in the availability of active sites and ultimately promoting the efficacy of the HER process. Moreover, an abundance of Mo doping in NiCo₂O₄ CNSPs hindered the active sites and functioned as a recombination center due to alterations in structure and composition. The results presented align with the LSV outcomes, as depicted in FIG. 6A.

The findings indicated that the NiMoₓCo₂₋ₓO₄ (x=0.04) CNSPs electrocatalyst had a higher roughness factor, specifically 21.3, than alternative Mo-doped NiCo₂O₄ CNSPs electrocatalysts. In addition, the roughness factor of the NiMoₓCo₂₋ₓO₄ CNSPs electrocatalyst (x=0.04) was approximately 2.7 times higher than that of the unmodified NiCo₂O₄ electrode, as depicted in FIG. 7A.

The number of represented electrodes (N) was determined through surface charge density (QS) analysis to mitigate the influence of the catalyst's active sites. The results indicated that the NiMoₓCo₂₋ₓO₄ (x=0.04) CNSPs electrocatalyst had a higher number of calculated active sites, at 6.0×10⁻⁵ mol/cm², compared to both the bare and other Mo-doped NiCo₂O₄ CNSPs electrocatalysts, as depicted in FIG. 7B. The findings indicated that the NiMoₓCo₂₋ₓO₄ CNSPs electrocatalyst was more effective in enhancing the HER process. This finding aligns with the LSV, Tafel plot, and ECSA analyses conducted on the electrodes selected as representatives. The specific activity (SA) was measured after the normalization of the ECSA to the current density at 300 mV in a 1M KOH solution. The NiMoₓCo₂₋ₓO₄ (x=0.04) CNSPs electrocatalyst demonstrated greater specific activity than the unmodified and other Mo-doped NiCo₂O₄ CNSPs electrodes, as depicted in FIG. 7C. Hence, the NiMoₓCo₂₋ₓO₄ (x=0.04) CNSPs electrocatalyst exhibits a significant increase in the HER activity.

Additional measurements utilizing EIS were conducted. The charge transfer kinetics at the semiconductor electrolyte interface (SEI) was evaluated by measuring the Nyquist plot of bare and Mo-doped NiCo₂O₄ CNSPs electrocatalyst at a potential of −0.3V RHE. The observed semicircles for bare and Mo-doped NiCo₂O₄ electrocatalysts are depicted in FIG. 7D. The NiMoₓCo₂₋ₓO₄ (x=0.04) CNSPs electrocatalyst demonstrated a reduced charge transfer resistance compared to the unmodified NiCo₂O₄ electrocatalyst. The SEI facilitated a more rapid charge transfer rate, enhancing the HER process. The results exhibited high concordance with the HER efficacy.

Extended CP evaluations on the NiMoₓCo₂₋ₓO₄ (x=0.04) CNSPs electrocatalyst were performed at a steady current density of 10 mA/cm², as depicted in FIG. 7E. Following a 36 h uninterrupted cathodic protection experiment, the electrochemical potential experienced a reduction of 12 mV, corresponding to a suppression factor of approximately 4%. The CP measurements revealed a minor range fluctuation attributable to the persistent emergence of bubbles that were subsequently eliminated from the electrocatalyst surface. The electrocatalyst NiMoₓCo₂₋ₓO₄ (x=0.04) CNSPs electrocatalyst demonstrated exceptional catalytic performance, maintaining its potential for 36 h.

The Tafel slope was employed to investigate rate-determining steps in the HER mechanism process for enhanced comprehension. Overall, Volmer, Heyrovsky, and Tafel reactions are generally employed to convert hydrogen protons into molecular hydrogen. Based on the underlying mechanisms, the amalgamation of the Volmer pathway alongside either the Heyrovsky or Tafel pathways produce molecular hydrogen. Typically, when the slope is around 120 mV/dec, the Volmer step mechanism is a limiting factor for the rate of reaction. The Heyrovsky or Tafel step mechanism is considered the rate-determining step when the slope is around 40 or 30 mV/dec, respectively. In accordance with the present disclosure, the Tafel slopes for NiMoₓCo₂₋ₓO₄ (x=0.04) CNSPs electrocatalyst were determined to be 61.9 mV/dec, as shown in FIG. 6C. The Volmer-Heyrovsky step mechanism determine the rate of reaction. Furthermore, FIG. 7F depicts a proposed schematic illustration of the Volmer-Heyrovsky step mechanism of HER in an alkaline environment.

### Example 9: DFT Calculations

DFT was employed to predict the activity of catalysts for the HER. DFT provides a location of the specific sites where hydrogen evolution may occur. In general, DFT involves designing transition metal-based catalyst materials and optimizing the electronic structure and surface properties thereof to enhance HER activity. In accordance with the present disclosure, first-principles calculations based on DFT were employed to investigate the impact of Mo dopants on catalytic and HER activity. DFT-based Quantum ATK software was utilized for designing and assessing a plurality of atomic configurations. The plurality of atomic configurations includes the adsorption of hydrogen (H) and water (W) molecules on both pristine CNSPs and Mo-doped CNSPs (MCNSPs). To accomplish this, the following atomic arrangements are utilized:
(1) H and W adsorption on the surface of CNSPs, denoted as CNSP—H and CNSP—W, respectively.
(2) H and W adsorption on MCNSPs with a Mo content of 1.8%, referred to as M_{I}CNSP—H and M_{I}CNSP—W, respectively.
(3) H and W adsorption on MCNSPs with a Mo content of 3.6%, designated as M_{II}CNSP—H and M_{II}CNSP—W, respectively.

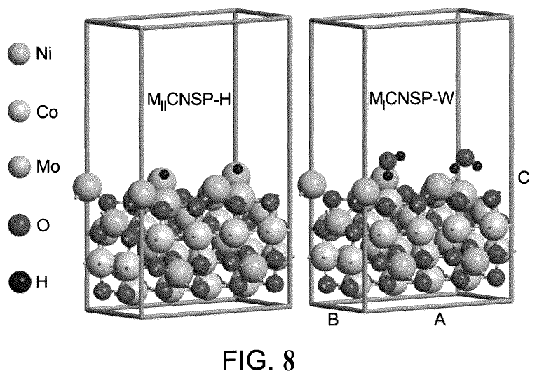

Additionally, the DFT analysis considered the adsorption of these molecules around the edge of the unit cell with a 3.6% Mo content to investigate the associated effects, denoted as M_{E}CNSP—H and M_{E}CNSP—W, respectively. The structure of CNSP was established using a unit cell including 56 atoms, specifically 8 Ni, 16 Co, and 32 O atoms. The associated lattice parameters were defined as follows: A=11.53 Å, B=5.76 Å, C=18.15 Å. A periodic-slab configuration was employed for the infinite (100) surface of CNSPs, which was oriented perpendicular to the z-axis (C-axis). This introduced non-periodicity in the C-direction due to the inclusion of a vacuum layer (around 13 Å thick) positioned directly above the surface to prevent interactions. FIG. 8 is a schematic illustration of unit cells for adsorption of hydrogen on molybdenum doped CNSP (M_{II}CNSP—H) and adsorption of water on molybdenum doped CNSP (M_{I}CNSP—W), respectively. The crystal structures were optimized to a stable configuration. To refine the atomic distances within modified unit cells, a force tolerance of 0.01 eV/Å was set. The spin-resolved generalized gradient approximation (SGGA) with Perdew-Burke-Ernzerhof (PBE) functional (SGGA.PBE) was selected for the exchange and correlation potential. SGGA was employed due to its effectiveness in describing the distribution of ions in the corresponding nanoparticles. The atomic cores were represented using Pseudo Dojo pseudopotentials. The electronic structure of valence electrons such as Ni 4s²3d⁸, Co 4s²3d⁷, Mo 5s¹4d⁵, and O 2s²2p⁴ was determined using high-basis sets of local numerical orbitals. A k-point sampling of was selected, along with a mesh cutoff energy of 125 Hartree, ensuring reasonable total energy convergence.

The chemical reactivity of the catalyst surfaces and their performance in the HER involve two key processes. Firstly, the adsorption and separation of water molecules, and secondly, the adsorption and release of hydrogen atoms. Introducing substitutional dopants enhances both reactivity and HER performance. To assess catalytic activity, the water molecules that adhere to the surface of the catalyst were examined. The adsorption energy (E_{A}) of the above-mentioned water molecules was calculated using the following formula:

$${E}_{A}^{W} = {E}_{system} - {E}_{slab} - {E}_{W}$$

where, E_{system} represents the overall energy of the nanoparticles, E_{slab} represents energy in the absence of water, and E_{W} represents energy of the water molecules. Adsorption energy indicates the level of interaction between the surface and the molecules immediately above it. A positive value indicates an unstable adsorption, while a negative E_{A} denotes an exothermic process that enables molecules to adhere to the surface. A more negative E_{A} signifies a more favourable adsorption of molecules. The magnitude of the adsorption energy determines whether a physisorption, as indicated by a less negative E_{A}, or chemisorption, as indicated by a more negative E_{A}, mechanism governs the process of molecule adsorption. The above-mentioned mechanisms are associated with changes in bond lengths and transfer of charge.

In accordance with the present disclosure, the water adsorption energies (E_{A}^{W}) were computed for four different catalysts, including CNSP—W, M_{I}CNSP—W, M_{II}CNSP—W, and M_{E}CNSP—W. The values are listed in Table 3, including −2.138 eV (−49.31 kcal/mol), −2.224 eV (−51.28 kcal/mol), −2.331 eV (−53.75 kcal/mol), and −2.332 eV (−53.78 kcal/mol), respectively. Further, on comparing the water adsorption energies, it was revealed that M_{E}CNSP—W exhibits a slightly more negative value than M_{II}CNSP—W. This indicates that M_{E}CNSP—W was relatively more stable and reactive in terms of water adsorption. The introduction of Mo dopants, which replace Co ions in both M_{E}CNSP—W and M_{II}CNSP—W, was attributed to the enhanced catalytic activity observed. The dissociation of water molecules was directly linked to the strength of their interaction with the surface atoms in the slab of the catalyst.

TABLE 3
E_{A}^{H(W)} values for the CNSP-H(W), M_{I}CNSP-H(W),
M_{II}CNSP-H(W) and M_{E}CNSP-H(W). Gibbs free energies of hydrogen
adsorption (ΔG^{H}) are also listed.

| | E_{A} (eV) | | |
|---|---|---|---|
| System | H | W | ΔG^{H} (eV) |
| CNSPFIGS | −2.517 | −2.138 | −0.49 |
| M_{I}CNSP | −2.521 | −2.224 | −0.48 |
| M_{II}CNSP | −2.541 | −2.331 | −0.59 |
| M_{E}CNSP | −2.544 | −2.332 | −0.61 |

Numerous modifications and variations of the present disclosure are possible in light of the above teachings. It is therefore to be understood that within the scope of the appended claims, the invention may be practiced otherwise than as specifically described herein.

The invention claimed is:

1. A method of generating hydrogen, comprising:
applying a potential of from 0.1 to 2 volts (V) to an electrochemical cell,
wherein the electrochemical cell is at least partially submerged in an aqueous solution,
wherein on the applying the potential the aqueous solution is reduced forming the hydrogen,
wherein the electrochemical cell comprises:
a counter electrode; and
an electrocatalyst,
wherein the electrocatalyst comprises:
a nickel foam substrate; and
NiMoₓCo₂₋ₓO₄ nanoparticles,
wherein x>0 and x≤0.06,
wherein the NiMoₓCo₂₋ₓO₄ nanoparticles are distributed on a surface of the nickel foam substrate,
wherein a first portion of the NiMoₓCo₂₋ₓO₄ nanoparticles have a nano-needle morphology,
wherein the nano-needles assemble to form a sphere in which the nano-needles project horizontally from the sphere, and
wherein the sphere has an average diameter of 1-5 micrometers (μm).

2. The method of claim 1, wherein the NiMoₓCo₂₋ₓO₄ nanoparticles have a cubic spinel oxide crystal structure.

3. The method of claim 1, wherein the NiMoₓCo₂₋ₓO₄ nanoparticles have a crystallite size of 12-18 nanometers (nm).

4. The method of claim 1, wherein Mo is only present at octahedral sites in the NiMoₓCo₂₋ₓO₄ nanoparticles.

5. The method of claim 1, wherein the nano-needles are uniformly spaced to form the sphere, and
wherein spacing between the nano-needles forms a porous structure.

6. The method of claim 1, wherein the nano-needles have an average width of 10-30 nm.

7. The method of claim 1, wherein a second portion of the NiMoₓCo₂₋ₓO₄ nanoparticles have a morphology of spheres with an average diameter of 0.1-3 μm.

8. The method of claim 7, wherein the NiMoₓCo₂₋ₓO₄ nanoparticles comprise 1-20% of the first portion and 80-99% of the second portion, based on a total amount of the NiMoₓCo₂₋ₓO₄ nanoparticles.

9. The method of claim 1, wherein the NiMoₓCo₂₋ₓO₄ nanoparticles comprise Ni(II), Ni(III), Co (II), and Co(III).

10. The method of claim 1, wherein the NiMoₓCo₂₋ₓO₄ nanoparticles are hydrothermally grown on the nickel foam substrate.

11. The method of claim 1, wherein the NiMoₓCo₂₋ₓO₄ nanoparticles form a continuous layer on the nickel foam substrate.

12. The method of claim 1, wherein the counter electrode comprises at least one of graphite and platinum.

13. The method of claim 1, wherein the aqueous solution comprises water and a base.

14. The method of claim 1, wherein the electrocatalyst has a Tafel slope of 60-115 millivolts/decade (mVdec⁻¹).

15. The method of claim 1, wherein x=0.04, and
the electrocatalyst has a Tafel slope of 60-65 mVdec⁻¹.

16. The method of claim 1, wherein the electrocatalyst has an overpotential of 200-300 millivolts (mV) at 10 mA/cm².

17. The method of claim 1, wherein x=0.04, and
the electrocatalyst has an overpotential of 220-230 mV at 10 mA/cm².

18. The method of claim 1, wherein the electrocatalyst has an electrochemically active surface area of 12-22 centimeters squared (cm²).
